(19) United States
(12) Patent Application Publication
(10) Pub. No.: US 2005/0270138 A1
(43) Pub. Date: Dec. 8, 2005

(54) Remote keyless entry device

(75) Inventor: Kouji Ikeda, Miyagi-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/144,237

(22) Filed: Jun. 2, 2005

(30) Foreign Application Priority Data
Jun. 4, 2004 (JP) 2004-167202

(51) Int. Cl. G05B 19/00

(52) U.S. Cl. 340/5.23; 340/5.72; 340/5.64; 340/426.36

(57) ABSTRACT

A vehicle receiver registers unique IDs of a plurality of portable transmitters in memory regions of a vehicle internal memory, and the plurality of portable transmitters registers each unique ID in a memory region of each portable internal memory. During a period for which an operation mode of the vehicle receiver is changed to a registration mode, when a predetermined operation member of the portable transmitter is operated according to a predetermined operation aspect, the IDs are transmitted to the vehicle receiver and are sequentially written in memory regions of the vehicle internal memory.

### BACKGROUND OF THE INVENTION

1. Field of the Invention

The present invention relates to a remote keyless entry device composed of two or more portable transmitters and one vehicle receiver, and more particularly, to a remote keyless entry device capable of performing register operation as simply as possible when unique IDs (identifications) assigned to a plurality of portable transmitters including a new portable transmitter are written and registered in a vehicle memory of a vehicle receiver in a case in which a currently used portable transmitter is lost and cannot be used.

2. Description of the Related Art

Generally, a remote keyless entry device includes two or more portable transmitters which are carried by a plurality of users commonly using one vehicle and to which unique IDs are respectively assigned and one vehicle receiver which is mounted in the vehicle and in which the unique IDs assigned to the respective portable transmitters are registered in an internal memory. In addition, when any one of the portable transmitters transmits an instruction signal including the unique ID assigned thereto to the vehicle receiver as a wireless signal, if the vehicle receiver receives the wireless signal, the remote keyless entry device detects whether the ID included in the instruction signal and the ID registered in the internal memory are equal to each other. At this time, if the IDs are equal to each other, a controlled portion of the vehicle is controlled in accordance with the instruction signal. For example, the door locking is released.

In such a remote keyless entry device, it is necessary that the unique IDs assigned to the two or more portable transmitters be written and registered in the internal memory of the vehicle receiver prior to using the remote keyless entry device. In this case, when the unique IDs are written and registered in the internal memory of the vehicle receiver, if the designated operation member of the vehicle receiver is operated according to a predetermined aspect, an operation mode of the vehicle receiver is changed from a common mode to a registration mode (writing mode). As a result, the unique ID can be written and registered in the internal memory of the vehicle receiver during a period for which the operation mode of the vehicle receiver is set to the registration mode.

These types of remote keyless entry devices have been known in which various means are used for a means for writing and registering the unique IDs assigned to the respective portable transmitters into the internal memory of the vehicle receiver.

Among them, one remote keyless entry device is disclosed in Japanese Unexamined Patent Application Publication No. 2001-115696. According to this remote keyless entry device, when an operation mode of the portable transmitter is set to the registration mode by an ID registration mode setting means, if a user operates the designated operation member according to a predetermined aspect, an ID corresponding to the operation is formed. At this time, the formed ID is registered in a memory as the unique ID of the portable transmitter. In addition, an operation mode of the vehicle receiver is set to a registration mode through a predetermined operation and an instruction signal including the unique ID of the portable transmitter is transmitted to the vehicle receiver. As a result, the unique ID is registered in the internal memory of the vehicle receiver. In addition, when IDs are registered with respect to a plurality of portable transmitters like a case in which a plurality of people use one vehicle, the same operation as the above-mentioned operation is performed with respect to the plurality of portable transmitters while an operation mode of the vehicle receiver becomes a registration mode.

In addition, as the specific structure in which unique IDs of a plurality of portable transmitters are registered in an internal memory of a vehicle receiver, a remote keyless entry device disclosed in Japanese Patent No. 3313249 has been known well. According to this device, when unique IDs of two or more portable transmitters are updated and registered in a plurality of memory regions of an internal memory of a vehicle receiver, in order to delete the unique IDs registered before updated from the internal memory, an unique ID of one portable transmitter which is updated and registered is registered in all memory regions and then unique IDs of the remaining portable transmitters which are updated and registered are sequentially registered in the memory regions.

In this case, the reason why an unique ID of one portable transmitter is written in all the memories of the portable transmitter is to increase a crime prevention function. More particularly, since there is a possibility that the vehicle receiver can be operated by using the lost portable transmitter if the ID with respect to the lost portable transmitter remains in the vehicle side memory, a unique ID of one portable transmitter is written in all the memories of the portable transmitter in order to prevent this case. In addition, according to a method that a predetermined ID of which all codes are 0 or F is overwritten in all the vehicle side memory and then the IDs of the portable transmitters are overwritten again, there is a possibility that the ID having the predetermined codes remains in the memory. That is, a possibility that the ID having the predetermined code is transmitted from the portable transmitter and the operation is made is high, the unique ID of one portable transmitter is written in all the memories of the portable transmitter in order to prevent this case.

In addition, when the portable transmitter is lost, if only data of the vehicle side memory in which an ID of the lost portable transmitter is stored can be changed to an ID of a newly used portable transmitter, it is possible to solve the above-mentioned problems. However, it is complicated to manage whether an ID of what portable transmitter is registered in what vehicle side memory. In addition, since the operation becomes complicated, this method is not used.

In addition, in the above-mentioned examples according to the related arts, as the method that the ID of the portable transmitter is written in the vehicle side memory, a method is used in which the portable transmitter transmits a signal and the ID of the portable transmitter included in the transmitting signal is automatically written. However, according to this method, by operating various switch installed in a main body of the vehicle, an input should be made. In this case, during a process of manufacturing the portable transmitter, a maker sets a predetermined ID, and notifies a registrant, such as a user or dealer, of the set ID. When the registrant registers the ID of the portable transmitter in the main body of the vehicle, the registrant sets an operation mode of the main body of the vehicle to an ID resister mode. For example, the registrant operates an up switch for power wind control to which 0 is assigned or a down switch to which 1 is assigned, the registrant should register an ID of predetermined bits composed of 0 and 1. Also in these examples according to the related arts, in order to increase the crime preventing function, the operation is performed by the number of memories in the main body of the vehicle.

Because of a reason for crime prevention, it is necessary to write the ID of the portable transmitter in the vehicle side memory a plurality of times. However, in Japanese Patent No. 3313249, when writing is performed after change of the operation mode to the ID registration mode, whether the writing is first writing is judged. When it is judged that the writing is first writing, the ID of the portable transmitter is automatically written in all the memories. As a result, there is a problem in that the program becomes complicated.

In addition, in a case in which by operating various switches, such as a power wind, installed in the main body of the vehicle, the ID of the same portable transmitter is written in the vehicle side memory a plurality of times, since it is necessary that the operation of the switch be performed the number of times equal to the number of bits of the ID of the portable transmitter, there is a problem in that register work becomes complicated.

### SUMMARY OF THE INVENTION

Accordingly, the present invention has been made to solve the above problems, and an advantage of the invention is that it provides a remote keyless entry device capable of updating and registering a unique ID of a portable transmitter without requiring the complicated program or much efforts when any one of a plurality of used portable transmitters is changed to a new portable transmitter.

According to a first aspect of the invention, there is provided a remote keyless entry device including a plurality of portable transmitters and one vehicle receiver, the respective portable transmitters transmitting an instruction signal including a unique ID assigned to each portable transmitter to the vehicle receiver as a wireless signal, the vehicle receiver controlling and driving a controlled member mounted on the vehicle according to the instruction signal when the vehicle receiver receives the wireless signal and confirms that the ID included in the instruction signal is the same as one of IDs stored in an internal memory of the vehicle receiver. Here, the plurality of portable transmitters store the unique IDs in memory regions of portable internal memories, respectively. The vehicle receiver stores the unique IDs of the plurality of portable transmitters in respective memory regions of the vehicle internal memory. During a period for which an operation mode of the vehicle receiver is set to a registration mode in which a unique ID of a portable transmitter is written and registered in each memory region of the vehicle internal memory, when a predetermined operation member of any one of the plurality of portable transmitters is operated according to a predetermined operation aspect, the ID stored in the portable internal memory of the portable transmitter is read out, the read out ID is repeatedly transmitted to the vehicle receiver the designated number of times, and the ID is sequentially written in respective memory regions of the vehicle internal memory.

Further, according to a second aspect of the invention, there is provided a remote keyless entry device including a plurality of portable transmitters and one vehicle receiver, the respective portable transmitters transmitting an instruction signal including a unique ID assigned to each portable transmitter to the vehicle receiver as wireless signal, the vehicle receiver controlling and driving a controlled member for vehicle according to the instruction signal when the vehicle receiver receives the wireless signal and confirms that the ID included in the instruction signal is the same to an ID stored a first memory region of an internal memory of the vehicle receiver. Here, the plurality of portable transmitters stores the unique IDs in memory regions of portable internal memories, respectively. The vehicle receiver stores the unique IDs of the plurality of portable transmitters in the first memory region of the vehicle internal memory. During a period for which an operation mode of the vehicle receiver is set to a registration mode in which a unique ID of a portable transmitter is written and registered in the vehicle internal memory, when a predetermined operation member installed in the vehicle is operated according to a predetermined operation aspect, the unique ID assigned to the portable transmitter is read out from a second memory region of the vehicle internal memory, and the ID is sequentially written in the first memory region of the vehicle internal memory.

According to the first aspect, it is preferable that when the predetermined operation member is operated according to the predetermined operation aspect, the portable transmitter further performs operation for designating the number of times of writing the unique ID, and when the corresponding unique ID is written in the memory regions of the vehicle internal memory, the vehicle receiver makes the unique ID repeatedly written in the memory regions by the designated number of times of writing the unique ID.

Further, according to the second aspect, it is preferable that the vehicle receiver includes an instruction unit for instructing to write the IDs written in the second memory region in the first memory region, and when the unique ID is written in the memory region of the vehicle internal memory, the unique ID is repeatedly written in the memory region by the number of times designated by the instruction unit.

According to a third aspect of the invention, there is provided a keyless entry device including a plurality of portable transmitters and one vehicle receiver, the respective portable transmitters transmitting an instruction signal including a unique ID assigned to each portable transmitter to the vehicle receiver as a wireless signal, the vehicle receiver controlling and driving a controlled member for vehicle according to the instruction signal when the vehicle receiver receives the wireless signal and confirms that the ID included in the instruction signal is the same as any one of IDs stored in an internal memory of the vehicle receiver. Here, the plurality of portable transmitters store the unique IDs in memory regions of portable internal memories, respectively. The vehicle receiver stores the unique IDs of the plurality of portable transmitters in respective memory regions of the vehicle internal memory. During a period for which an operation mode of the vehicle receiver is set to a registration mode in which a unique ID of a portable transmitter is written and registered in each memory region of the vehicle internal memory, when a predetermined operation member provided in any one of the portable transmitters or a predetermined operation member provided in the vehicle is operated according to a predetermined operation aspect, a random ID different from the unique ID of the portable transmitter is sequentially written in respective memory regions of the vehicle internal memory by the designated number of times. In addition, when an operation member different from the operation member is operated according the operation aspect or the operation member is operated according to an operation aspect different from the operation aspect, the unique ID of the portable transmitter is written in the vehicle internal memory.

### BRIEF DESCRIPTION OF THE DRAWINGS

FIG. 1 is a block diagram showing a structure of essential elements of a portable transmitter in a remote keyless entry device according to a first embodiment of the invention;

FIG. 2 is a block diagram showing a structure of essential elements of a portable transmitter in a remote keyless entry device according to a first embodiment of the invention;

FIG. 3 is an explanatory view illustrating change states in which IDs are written and registered in four memory regions of an internal memory for vehicle;

FIG. 4 is a block diagram showing a structure of essential elements of a vehicle receiver in a remote keyless entry device according to a second embodiment of the invention; and

FIG. 5 is an explanatory view illustrating a state in which IDs are written and registered in four memory regions in each of a keyless entry devices according to third and fourth embodiments of the invention.

### DESCRIPTION OF THE PREFERRED EMBODIMENT

Hereinafter, preferred embodiments of the present invention will be described with reference to the accompanying drawings.

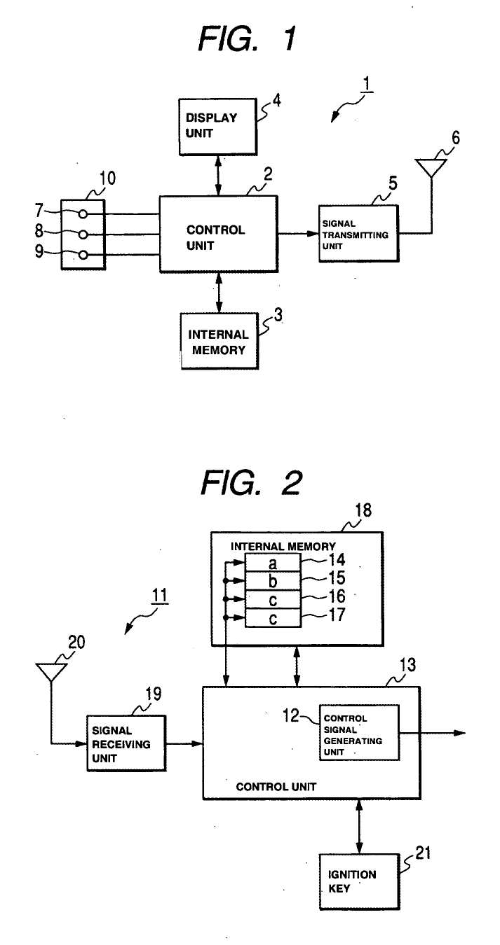

FIGS. 1 and 2 are block diagrams showing a remote keyless entry device according to a first embodiment of the present invention. More particularly, FIG. 1 is a block diagram showing a structure of essential elements of a portable transmitter and FIG. 2 is a block diagram showing a structure of essential elements of a vehicle receiver.

As shown in FIG. 1, a portable transmitter 1 according to the first embodiment includes a control unit 2, a portable internal memory 3 which is composed of an EEPROM for storing an unique ID with respect to the portable transmitter 1, a display unit 4 composed of display lamps, a signal transmitting unit 5, a wireless signal transmitting antenna 6, and a switch operation unit 10 which is composed of a door locking switch 7, a door un-locking switch 8, and a setting switch 9.

In addition, the control unit 2 is connected to the portable internal memory 3, the display unit 4, an input terminal of the signal transmitting unit 5, the door locking switch 7, the door un-locking switch 8, and the setting switch 9. An output end of the signal-transmitting unit 5 is connected to the wireless signal-transmitting antenna 6.

Further, as shown in FIG. 2, the vehicle receiver 11 according to the first embodiment includes a control unit 13 which has a control signal generating unit 12 built therein, a vehicle internal memory 18 composed of an EEPROM having a plurality of memory region elements 14, 15, 16, and 17 in which the respective IDs are stored, a signal receiving unit 19, and a wireless signal receiving antenna 20.

Furthermore, the control unit 13 is connected to the plurality of memory region elements 14, 15, 16, and 17 and an output terminal of the signal receiving unit 19, and an input terminal of the signal receiving unit 19 is connected to the wireless signal receiving antenna 20. In addition, the control signal generating unit 12 is connected to a controlled member of the vehicle (not shown in FIG. 2), for example, a door locking member (not shown in FIG. 2), and the control unit 13 is connected to an ignition key 21 of the vehicle.

In addition, the remote keyless entry device according to the present embodiment will be described using a case in which three people use one vehicle. The portable transmitters 1 which use the vehicle receiver 11 shown in FIG. 2, that is, which can transmit regular wireless signals to the vehicle receiver 11 are three. When unique IDs been assigned to these three portable transmitters 1 are a, b, and c, the IDs has been already registered in the four memory region elements 14, 15, 16, and 17 of the vehicle internal memory 18. In an example shown in FIG. 2, a has been written and registered in the memory region element 14, b has been written and registered in the memory region element 15, and c has been written and registered in the memory region elements 16 and 17.

The door locking switch 7 and the door un-locking switch 8 are composed of push button switches. The door locking switch 7 and the door un-locking switch 8 are disposed and the operation unit is exposed on a surface of the portable transmitter 1. The setting switch 9 is composed of an absolute rotary encoder, has a memory having setting values 1 to 4 is attached thereto, and outputs signals corresponding to the respective locations. In addition, the operation unit is generally covered with a cover and is accommodated therein. When IDs are registered, which will be described later, a user can open the cover and operate the operation unit.

The operation of the portable transmitter 1 and the vehicle receiver 11 having the above-mentioned structure will be described.

First, the description will be made with respect to an operation example of a case in which the user releases the door locking of the vehicle using the user's portable transmitter 1 when an operation mode of the vehicle receiver 11 is set to a common mode.

When the user goes toward the vehicle with the user's portable transmitter 1 and presses the door un-locking switch 8 of the portable transmitter 1 at a location adjacent to the vehicle, the control unit 2 reads out a unique ID with respect to the portable transmitter 1 (in this case, a) written and registered in the portable internal memory 3 and simultaneously reads out a functional code for achieving a door un-locking function from the portable internal memory 3, in response to the pressing operation of the door un-locking switch 8. Then, the control unit 2 forms an instruction signal including the read out unique ID and supplies the formed signal to the signal transmitting unit 5. When the instruction signal is supplied, the signal transmitting unit 5 converts the instruction signal into a frequency signal suitable for transmitting a wireless signal and amplifies the converted frequency signal so as to form a transmitting signal having a predetermined signal level. Then, the signal transmitting unit 5 transmits the transmitting signal to the vehicle receiver 11 through the wireless signal transmitting antenna 6 by wireless.

At this time, when the vehicle receiver 11 receives the wireless signal transmitted from the portable transmitter 1 through the wireless signal receiving antenna 20, the signal receiving unit 19 regenerates the instruction signal from the received signals to supply it to the control unit 13. When the instruction signal is supplied, the control unit 13 extracts the ID and functional code included in the instruction signal. In addition, the control unit 13 determines whether the extracted ID is the same as one of the IDs written and registered in the plurality of memory region elements 14, 15, 16, and 17 of the vehicle memory 18. In this case, since the extracted ID is a and is the same as the ID a written and registered in the memory region element 14, the control unit 13 determines that the same ID has been written and registered in the memory region element of the vehicle memory 18, that is, the extracted ID is a regular ID. Next, since the extracted ID is the regular ID, the control unit 13 supplies the extracted functional code to the control signal generating unit 12. The control signal generating unit 12 forms a control signal for controlling the controlled member according to the instruction of the functional code, that is, a door un-locking signal (in this case), and supplies the door un-locking signal to the controlled member, that is, a door locking mechanism. In this way, the locking state of the door locking mechanism is released and the door locking is released.

Further, when the door of the vehicle is in an un-locking state, if the user presses the door locking switch 7 of the portable transmitter 1, the door locking signal is supplied to the door locking mechanism through substantially the same operation process as the above-mentioned operation process. As a result, the door is changed from the unlocked state to the locked state.

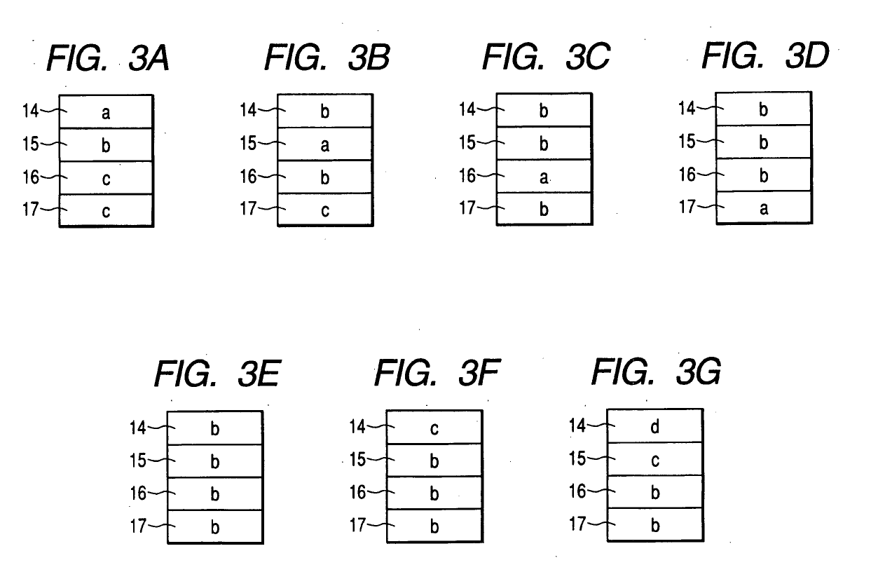

When one portable transmitter 1 having the ID a among the three portable transmitters 1 commonly using the vehicle receiver 11 is lost or damaged, the portable transmitter 1 cannot be used anymore. Accordingly, it is necessary to prepare a new portable transmitter 1 with an ID d for replacing the unusable portable transmitter 1, and to register the unique IDs of three portable transmitters 1 including the new portable transmitter 1 in the vehicle internal memory 18 of the vehicle receiver 11. An operation example at the time of the registration will be described with reference to FIGS. 3A to 3G, which show change states of the IDs written and registered in the four memory region elements 14, 15, 16, and 17 of the vehicle internal memory 18.

In this case, for convenience sake, it is assumed that the unique ID assigned to the unusable portable transmitter 1 is a, the unique IDs assigned to the two portable transmitters 1 which can be continuously used are b and c, and the unique ID assigned to the newly prepared portable transmitter 1 is d. In addition, in the four memory region elements 14, 15, 16, and 17 for the vehicle internal memory 18 before updating the registration, it is assumed that a has been written and registered in the memory region element 14, b has been written and registered in the memory region element 15, and c has been written and registered in the memory region elements 16 and 17, as shown in FIG. 3A.

First, the operation mode of the vehicle receiver 11 is changed from the common mode used until now to a registration mode. When the user repeats a predetermined operation of the ignition key 21 of the vehicle a predetermined number of times during a predetermined time, the operation mode is changed from the common mode to the registration mode. In addition, when the operation mode of the vehicle is changed to the registration mode, a hazard lamp, which is provided in the vehicle, flickers once. With respect to returning the operation mode of the vehicle receiver 11 to the common mode, the operation mode may automatically return to the common mode when predetermined time elapses after the operation mode is changed to the registration mode. When the operation mode is in the registration mode, the operation mode may return to the common mode by operating a power window switch provided in the vehicle according to a predetermined sequence or by operating a separately provided returning button.

During a period for which the operation mode of the vehicle receiver 11 is in the registration mode, the user selects one portable transmitter 1, for example, the portable transmitter 1 with the unique ID b among the three portable transmitters 1 to be newly registered, and writes and registers the unique ID b assigned to the selected portable transmitter 1 into the vehicle internal memory 18 of the vehicle receiver 11 through the following operation process.

Specifically, when the user presses the functional switch of any one of the three portable transmitter 1, for example, the door un-locking switch 8 and simultaneously sets the setting switch 9 to a position showing a predetermined setting value (4 indicating the number of the memory region elements 14, 15, 16, and 17 in this case), in response to the pressing operation of the door un-locking switch 8, the control unit 2 repeatedly read out the unique ID (in this case, b) written and registered in the portable internal memory 3 the setting number of times of the setting switch 9 (that is, four times in this case), allows an instruction signal including the unique ID to be formed whenever the unique ID is read out, and supplies the formed instruction signal to the signal transmitting unit 5. Whenever the signal transmitting unit 5 is supplied with the instruction signal, it converts the instruction signal into the wireless signal and repeatedly transmits the converted signal to the vehicle receiver 11 by wireless.

At this time, whenever the vehicle receiver 11 receives the wireless signal transmitted from the portable transmitter 1, the signal receiving unit 19 regenerates the instruction signal from the received signal and supplies the regenerated signal to the control unit 13. Whenever the control unit 13 is supplied with the instruction signal, it extracts the ID (in this case, b) included in the instruction signal and supplies the extracted ID to the memory region element 14 of the vehicle internal memory 18.

When a first ID is supplied to the vehicle internal memory 18, the corresponding ID is supplied to the memory region element 14, and the ID a previously registered in the memory region 14 is overwritten with b. When the overwriting registration is performed, a, b, c, and c which has been registered in the memory region elements 14, 15, 16, and 17, are shifted to next memory region elements 15, 16, and 17 one-by-one as shown in FIG. 3B. As a result, a is overwritten and registered in the memory region element 15, b is overwritten and registered in the memory region element 16, and c is overwritten and registered in the memory region element 17.

Next, when a second ID is supplied to the vehicle internal memory 18, the ID is supplied to the memory region element 14, and the ID b been already registered in the memory region 14 is overwritten with a new b. When the overwriting register is performed, b, a, b, and c, which has been already registered in the memory region elements 14, 15, 16, and 17, are shifted to next memory region elements 15, 16, and 17 one-by-one, as shown in FIG. 3C. As a result, b is overwritten and registered in the memory region element 15, a is overwritten and registered in the memory region element 16, b is overwritten and registered in the memory region element 17, and c is deleted from the memory.

Next, when a third ID is supplied to the vehicle internal memory 18, the ID is supplied to the memory region element 14, and the ID b been already registered in the memory region element 14 is overwritten with a new b. When the overwriting register is performed, b, b, a, and c, which have been already registered in the memory region elements 14, 15, 16, and 17, are shifted to next memory region elements 15, 16, and 17 one-by-one, as shown in FIG. 3D. As a result, b is overwritten and registered in the memory region element 15, b is overwritten and registered in the memory region element 16, a is overwritten and registered in the memory region element 17, and b been already registered in the memory region 17 is deleted from the memory.

Next, when a fourth ID is supplied to the vehicle internal memory 18, the ID is supplied to the memory region element 14, and the ID b been already registered in the memory region 14 is overwritten with a new b. When the overwriting registration is performed, b, b, b, and a, which have been registered in the memory region elements 14, 15, 16, and 17, are shifted to next memory regions 15, 16, and 17 one-by-one, as shown in FIG. 3E. As a result, b is overwritten and registered in the memory region element 15, b is overwritten and registered in the memory region element 16, b is overwritten and registered in the memory region 17, and a is deleted from the memory. As a result, only b is registered in all the memory region elements 14, 15, 16, and 17.

Next, during a period for which the operation mode of the vehicle receiver 11 is in the registration mode, the user selects another portable transmitter 1 having a unique ID c among the three portable transmitters 1 to be newly registered, and writes and registers the unique ID c assigned to the selected portable transmitter 1 into the internal memory 18 of the vehicle receiver 11.

In the present operation, a setting value of the setting switch 9 is set to 1. Since the other operation is the same as the above-mentioned operation, the description thereof is omitted. As a result, as shown in FIG. 3F, c is registered in the memory region element 14, the IDs been registered in the memory region elements 14, 15, and 16 are shifted to the memory region elements 15, 16, and 17. The IDs c, b, b, and b are registered in the memory region elements 14, 15, 16, and 17, respectively.

Next, the user selects the remaining one portable transmitter 1, for example, the portable transmitter with the unique ID d among the three portable transmitters 1 to be newly registered, and writes and registers the unique ID d assigned to the selected portable transmitter 1 into the internal memory 18 of the vehicle receiver 11.

In the present operation, a setting value of the setting switch 9 is set to 1. Since the other operation is the same as the above-mentioned operation, the description thereof is omitted. As a result, as shown in FIG. 2G, d is registered in the memory region element 14, and the Ids, which have been registered in the memory region elements 14, 15, and 16, are shifted to the memory region elements 15, 16, and 17. The IDs d, c, b, and b are registered in the memory region elements 14, 15, 16, and 17, respectively.

Further, the ID b is registered in the memory region element 16, and the ID b is registered in the memory region element 17. Then, three portable transmitters 1 having IDs b, c, and d can commonly use the vehicle receiver 11, and the portable transmitter 1 having the ID a cannot be used at the same time.

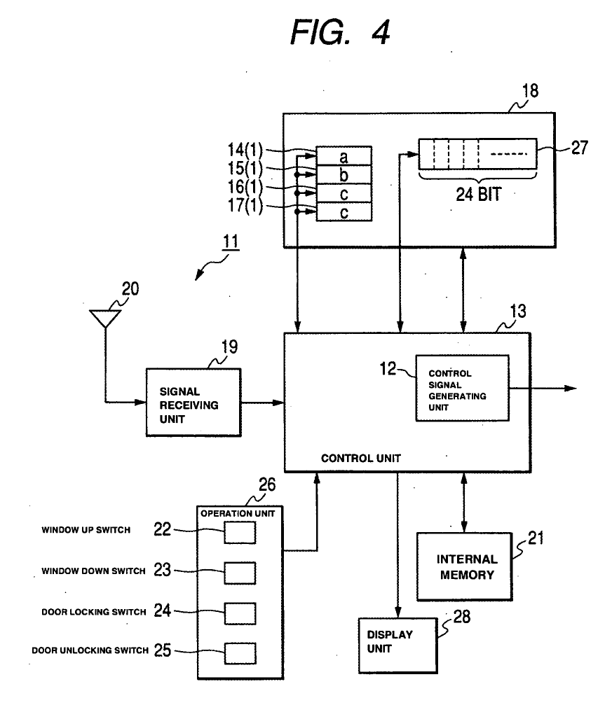

Next, FIG. 4 is a block diagram showing a structure of essential elements of a vehicle receiver in a remote keyless entry device according to a second embodiment of the invention.

The remote keyless entry device according to the first embodiment shown in FIG. 2 (hereinafter, referred to the former) and the remote keyless entry device according to the second embodiment shown in FIG. 4 (hereinafter, referred to as the latter) are largely different from each other in that the vehicle receiver 11 reads out and registers the IDs from the signals transmitted from the portable transmitter 1 in the former, but a power window up switch and a power window down switch provided in the vehicle are operated and the ID of the previously recognized portable transmitter 1 is inputted and registered in the latter. In addition, the keyless entry device according to the first embodiment and the keyless entry device according to the second embodiment are mainly different from each other in that the memory regions of the internal memory for vehicle 18 are different, an operation unit 26 and a display unit 28 are connected to the control unit 13 in the latter, and the control of the control unit 13 is different.

The latter vehicle internal memory 18 is different from the former internal memory in that it has a first memory region having memory region elements 14(1), 15(1), 16(1), and 17(1) corresponding to the former memory region elements 14, 15, 16, and 17 and a second memory region having one memory region element 27.

Further, the operation unit 26 includes functional switches such as a power window up switch 22 and a power window down switch 23 becoming an ID input unit when an operation mode of the vehicle receiver 11 is set to an ID registration mode, a door locking switch 24 for fixing the input ID to write it in the second memory region, and a door un-locking switch 25 becoming an instruction unit for instructing to write the data written in the second memory region into the first memory region after the registration of the ID having predetermined bits into a second internal memory is finished. In addition, when the door locking switch 24 and the door un-locking switch 25 are simultaneously pressed, all the data in the second memory region are deleted, it becomes a state in which writing can be made from the first bit.

In addition, functions assigned to the respective switches can be changed in various manners. For example, when an ID having a predetermined digit is inputted, the door locking switch 24 may have a function of an instruction unit for instructing to write the data written in the second memory region into the first memory region.

When an operation mode of the vehicle receiver 11 does not become the ID registration mode, the display unit 28 functions as a television set or a display for a car navigation system. However, when the operation mode of the vehicle receiver 11 becomes the ID registration mode, the display unit 28 displays a message that the operation mode becomes the ID registration mode and displays the ID inputted by the ID input unit for every bit.

On the other hand, since the operation when the operation mode of the vehicle receiver 11 becomes the common mode in the latter is the same as that when the operation mode becomes the common mode in the former, the operation when the operation mode becomes the common mode in the latter will not be described in order to avoid a repeated description.

In addition, since the operation process when the operation mode of the vehicle receiver 11 is changed from the common mode to the registration mode in the latter is the same as that when the operation mode of the vehicle receiver 11 is changed from the common mode to the registration mode in the former, the operation process in the latter is not described in order to avoid a repeated description.

Next, in the case of the latter, the operation when writing and registering the unique IDs of the three portable transmitters 1 to be newly registered in the vehicle internal memory 18 of the vehicle receiver 11 will be described. In this case, it is assumed that when the portable transmitter 1 having the unique ID d is lost, a portable transmitter 1 having a unique ID c is newly registered, and the portable transmitters 1 having the unique IDs a and b are continuously used.

During a period for which the operation mode of the vehicle receiver 11 is in the registration mode, the user selects one portable transmitter 1 among three portable transmitters 1 to be newly registered, for example a portable receiver 1 having a unique ID c composed of a binary number of 24 bits, and writes and registers the unique ID c assigned to the selected portable transmitter 1 into the first memory region of the vehicle internal memory 18 of the vehicle receiver 11 through the following operation process.

Specifically, when the operation mode of the vehicle receiver 11 is set to the registration mode, at an initial state, the memory region element 27 is set to a state in which writing can be performed from one bit. In addition, the operator such as the user or the dealer confirms a unique ID c of the portable transmitter 1 composed of a binary number of plural bits, such as 24 bits, written in a written guarantee of the portable transmitter 1. While confirming the written guarantee, the operator presses the power window up switch 22 in a case in which each bit is 1, and presses the power window down switch 23 in a case in which each bit is 0. Whenever pressing the up and down switches, the operator presses the door locking switch 24 to fix it. When it is fixed, the data can be written in the next bits. Therefore, the data are written at memory locations corresponding to the respective bits of the memory region element 27. At this time, on the display unit 28, the inputted value 0 or 1 is displayed at the display locations corresponding to the respective bits. When the operator presses the door locking switch 24 to fix it, it is shifted to the next bit location.

In addition, at the time when registration are finished with respect to all the bits, when the door un-locking switch 25 is pressed, the ID of the memory region element 27 is transmitted to the control unit 13 to be written into the memory region element 14 (1) of the first memory region 14. As such, similar to the former, the IDs stored in memory region elements 14 (1) to 16 (1) are overwritten in the memory region elements 15 (1) to 17 (1), and the ID stored in the memory region element 17 (1) is deleted. In addition, when the operator presses the door un-locking switch 25 three times and presses the unique ID c of the portable transmitter 1, the same operation is performed, and all the IDs stored in the memory region elements 14 (1) to 17 (1) become b. Then, during a period for which the operation mode of the vehicle receiver 11 is set to the registration mode, one portable transmitter 1 having a unique ID b among the three portable transmitters 1 to be newly registered is registered.

More particularly, first, the user simultaneously presses the door locking switch 24 and the door un-locking switch 25 to delete all the data in the second memory region, and makes it become a state in which writing can be performed from one bit. Since the process subsequent to the process described above is the same as the above-mentioned case, it is omitted. In this case, the door un-locking switch 25 is pressed once.

Next, with regard to another portable transmitter 1 having an unique ID a among the three portable transmitters 1 to be newly registered, the same operation as the above-mentioned portable transmitter 1 having the unique ID b is performed.

As a result, as shown in FIG. 4, the IDs a, b, c, and c are registered in the memory region elements 14(1) to 17(1). Accordingly, it is not possible to use the portable transmitter 1 having the unique ID d, and it is possible to use the portable transmitters 1 having the unique IDs a, b, and c.

In addition, in the above-mentioned embodiments, by operating once the door un-locking switch 25 functioning as the instruction unit, it is constructed such that the unique ID of the second memory region is written into the first memory region once. However, by providing the same setting means as the example of the former, it may be constructed such that if pressing the analog switch 25 by the number of times set by the setting means, that is, once, the instruction signal is transmitted.

In addition, according to another embodiment described above, by providing the various switches 22 to 25 for achieving the various functions in the operation unit 26, the unique ID is registered. However, by providing a touch panel in the display, the unique ID may be inputted by operating the touch panel.

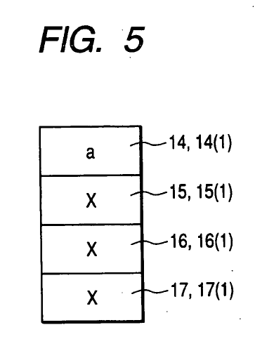

Next, a third embodiment of the invention will be described. The third embodiment of the invention is different from the first embodiment in that when the door locking switch 7 and the door un-locking switch 8 of the portable transmitter 1 are simultaneously pressed, a random ID composed of a binary number of 24 bits is generated, and a signal including a signal part corresponding to the random ID instead of the signal part corresponding to the ID part of the door locking signals as the random ID is generated. For the simplification, in FIG. 5, only the case in which the portable transmitter 1 having the unique ID a is registered in the vehicle receiver 11 has been described. However, when the setting means 9 is set to 4 and the door locking switch 7 and the door un-locking switch 8 are simultaneously pressed, the random IDs (in FIG. 5, displayed with a character X) are registered in the memory region elements 14 to 17 through the same operation as in the first embodiment. After that, when the door locking switch 7 is pressed, the ID a is registered in the memory region element 14 and the random IDs are stored in the memory region elements 15 to 17 through the same operation as in the first embodiment, as shown in FIG. 5. In addition, since the random ID is a value which is randomly selected in a range of 0 to 2²⁴, there is a little possibility that the value is equal to the unique ID of the portable transmitter 1, so that the above problem hardly occurs.

Next, a fourth embodiment will be described. Similar to the third embodiment, the fourth embodiment is different to the other embodiments in that an operation member for generating a random ID is provided. The random ID is generated by pressing the power window up switch 22 and the power window down switch 23 simultaneously and is stored in the second memory region. Therefore, with respect to a case in which only a portable transmitter 1 having the unique ID a is registered in the vehicle receiver 11, when the power window up switch 22 and the power window down switch 23 are simultaneously pressed and then the door un-locking switch 25 functioning as an instruction unit is pressed four times, the random IDs are registered in all the memory region elements in the first memory region. Next, when the same process as when the ID of the portable transmitter 1 having the unique ID a is registered in the second embodiment is performed, the ID is registered in the first memory region, as shown in FIG. 5. In addition, according to the fourth embodiment, when the random ID is registered, a designation means for designating the number of times of registration may be provided, and the random ID may be directly registered in the first memory without registering the random ID in the second memory region.

As described above, according to the remote keyless entry device of the prevent invention, in a case in which the unique ID of the portable transmitter is registered in the internal memory for vehicle of the vehicle receiver, when the predetermined operation member of any one of the portable transmitters is operated according to the predetermined operation aspect, the ID stored in the portable memory of the portable transmitter is read out, the read ID is repeatedly transmitted to the vehicle receiver the designate number of times, and the ID is sequentially written in each memory region of the internal memory for vehicle. Therefore, by only operating the portable transmitter by the small number of times, it is possible to write and register the unique ID of the portable transmitter in the plurality of memory regions. In addition, it is possible to register the unique ID of the portable transmitter without requiring many efforts.

Further, according to the remote keyless entry device of the prevent invention, in a case in which the unique ID of the portable transmitter is registered in a second memory region of the internal memory for vehicle of the vehicle receiver, when the predetermined operation member provided in the vehicle is operated according to the predetermined operation aspect, the ID is repeatedly read out from the second memory region the designated number of times, and the ID is sequentially written in the first memory region of the internal memory for vehicle. Therefore, by only operating the operation member provided in the vehicle by the small number of times, it is possible to write and register the unique ID of the portable transmitter in the plurality of memory regions. In addition, it is possible to register the unique ID of the portable transmitter without requiring many efforts.

Furthermore, according to the remote keyless entry device of the invention, when the predetermined operation member of the portable transmitter is operated according to the predetermined operation aspect, the portable transmitter further perform operation for designating the number of times of writing the unique ID, and when the vehicle receiver writes the corresponding unique ID in memory regions of the internal memory for vehicle, the vehicle receiver make the unique ID repeatedly written in the memory region by the designated number of times of writing the unique ID. Therefore, by only operating the portable transmitter by the small number of times, it is possible to write and register the unique ID of the portable transmitter in the plurality of memory regions of the internal memory for vehicle by the designated number of times of writing the ID. In addition, it is possible to register the unique ID of the portable transmitter without requiring many efforts.

Further, according to the remote keyless entry device of the invention, the vehicle receiver includes a designating unit for designating the number of times of writing the unique IDs, and when the unique ID is written in the memory regions of the internal memory for vehicle, the unique ID can be repeatedly written in the memory region by the number of times designated by the designation unit. Therefore, by only operating the operation member provided in the vehicle by the small number of times, it is possible to write and register the unique ID of the portable transmitter in the plurality of memory regions of the internal memory for vehicle by the designated number of times of writing the ID. In addition, it is possible to register the unique ID of the portable transmitter without requiring many efforts.

Furthermore, according to the remote keyless entry device of the invention, during a period for which the operation mode of the vehicle receiver is set to the registration mode, when the predetermined operation member is operated according to a predetermined operation aspect, random IDs different from the unique IDs of the plurality of portable transmitters are repeatedly written in the memory regions by the designated number of times, and the unique IDs of the portable transmitters are also written in the internal memory for vehicle. Therefore, since a different random ID can be set instead of the ID of the lost portable transmitter, the invention is excellent in crime prevention. In addition, when the random ID is written in the plurality of memory regions of the vehicle receiver, by only operating the operation member by the small number of times, the random IDs can be written in the plurality of memory regions of the internal memory for vehicle, it is possible to register the random unique ID of the portable transmitter without requiring much efforts.

1. A remote keyless entry device including a plurality of portable transmitters and one vehicle receiver, the respective portable transmitters transmitting an instruction signal including a unique ID assigned to each portable transmitter to the vehicle receiver as a wireless signal, the vehicle receiver controlling and driving a controlled member mounted on a vehicle according to the instruction signal when the vehicle receiver receives the wireless signal and confirms that the ID included in the instruction signal is the same as one of IDs stored in an internal memory of the vehicle receiver,
wherein the plurality of portable transmitters store the unique IDs in memory regions of portable internal memories, respectively,
the vehicle receiver stores the unique IDs of the plurality of portable transmitters in respective memory regions of the vehicle receiver internal memory, and
during a period for which an operation mode of the vehicle receiver is set to a registration mode in which a unique ID of a portable transmitter is written and registered in each memory region of the vehicle receiver internal memory, when a predetermined operation member of any one of the plurality of portable transmitters is operated according to a predetermined operation aspect, the ID stored in the portable internal memory of the portable transmitter is read out, the read out ID is repeatedly transmitted to the vehicle receiver a designated number of times, and the ID is sequentially written in respective memory regions of the vehicle receiver internal memory.

2. A remote keyless entry device including a plurality of portable transmitters and one vehicle receiver, the respective portable transmitters transmitting an instruction signal including a unique ID assigned to each portable transmitter to the vehicle receiver as wireless signal, the vehicle receiver controlling and driving a controlled member for vehicle according to the instruction signal when the vehicle receiver receives the wireless signal and confirms that the ID included in the instruction signal is the same to an ID stored a first memory region of an internal memory of the vehicle receiver,
wherein the plurality of portable transmitters stores the unique IDs in memory regions of portable internal memories, respectively,
the vehicle receiver stores the unique IDs of the plurality of portable transmitters in the first memory region of the vehicle internal memory, and
during a period for which an operation mode of the vehicle receiver is set to a registration mode in which a unique ID of a portable transmitter is written and registered in the vehicle internal memory, when a predetermined operation member installed in the vehicle is operated according to a predetermined operation aspect, the unique ID assigned to the portable transmitter is read out from a second memory region of the vehicle receiver internal memory, and the ID is sequentially written in the first memory region of the vehicle receiver internal memory.

3. The remote keyless entry device according to claim 1,
wherein when the predetermined operation member is operated according to the predetermined operation aspect, the portable transmitter further performs an operation for designating the number of times of writing the unique ID, and
when the corresponding unique ID is written in the memory regions of the vehicle receiver internal memory, the vehicle receiver makes the unique ID repeatedly written in the memory regions by the designated number of times of writing the unique ID.

4. The remote keyless entry device according to claim 2,
wherein the vehicle receiver includes an instruction unit for instructing to write the IDs written in the second memory region in the first memory region, and
when the unique ID is written in the memory region of the vehicle receiver internal memory, the unique ID is repeatedly written in the memory region by the number of times designated by the instruction unit.

5. A keyless entry device including a plurality of portable transmitters and one vehicle receiver, the respective portable transmitters transmitting an instruction signal including a unique ID assigned to each portable transmitter to the vehicle receiver as a wireless signal, the vehicle receiver controlling and driving a controlled member for a vehicle according to the instruction signal when the vehicle receiver receives the wireless signal and confirms that the ID included in the instruction signal is the same as any one of IDs stored in an internal memory of the vehicle receiver,
wherein the plurality of portable transmitters store the unique IDs in memory regions of portable internal memories, respectively,
the vehicle receiver stores the unique IDs of the plurality of portable transmitters in respective memory regions of the vehicle receiver internal memory, and
during a period for which an operation mode of the vehicle receiver is set to a registration mode in which a unique ID of a portable transmitter is written and registered in each memory region of the vehicle receiver internal memory, when a predetermined operation member provided in any one of the portable transmitters or a predetermined operation member provided in the vehicle is operated according to a predetermined operation aspect, a random ID different from the unique ID of the portable transmitter is sequentially written in respective memory regions of the vehicle internal memory by the designated number of times, and
when an operation member different from the operation member is operated according the operation aspect or the operation member is operated according to an operation aspect different from the operation aspect, the unique ID of the portable transmitter is written in the vehicle receiver internal memory.
